(19) United States
(12) Patent Application Publication
(10) Pub. No.: US 2005/0245243 A1
(43) Pub. Date: Nov. 3, 2005

(54) System and method for wireless delivery of audio content over wireless high speed data networks

(76) Inventor: Michael A. Zuniga, Fairfax, VA (US)

Correspondence Address: JONES DAY, 222 EAST 41ST ST, NEW YORK, NY, 10017, US

(21) Appl. No.: 10/835,391

(22) Filed: Apr. 28, 2004

(51) Int. Cl. H04M 11/10

(52) U.S. Cl. 455/414.3; 455/414.1

(57) ABSTRACT

A system and method that facilitate efficient use of 3G high-speed data networks while providing for personalized audio content selection and coordinated distribution of selected content are disclosed. The invention categorizes audio content to be delivered over wireless networks such that the categories correspond to a different delivery priority. In an illustrative three-category implementation, category 1 content has the highest delivery priority for delivery as soon as possible, category 2 content has the next highest delivery priority for delivery, and category 3 content, such as music, audio books and so on, has the least urgent delivery priority. The categories are used to coordinate audio content delivery to efficiently use available bandwidth and network resources by delivering content at off-peak times. The invention also allows the downloading process to be interruptible such that it can be resumed at about the point of an interruption to conserve resources.

### FIELD OF THE INVENTION

The invention relates to the field of delivering digital entertainment media to mobile users.

### BACKGROUND OF THE INVENTION

Third generation (3G) cellular systems offer high-speed data services to mobile customers that are expected to enable subscribers to access web sites of interest, and to send and receive e-mail, text, audio content, and other multimedia content. The provision of audio content is a service that attracts discerning subscribers who are relatively intolerant of poor quality reception. Moreover, individual preferences tend to vary significantly for specific audio content. Thus customization of audio content coupled with the delivery of high quality audio content is an attractive inducement to potential subscribers of wireless services.

The existing audio distribution models either cannot be sufficiently customized, as in the case of radio, or require significant investment of time, such as in copying tapes and CDs for replaying in an automobile. Additional audio distribution methods being considered, such as audio streaming and the downloading of audio files, such as MP3 files, on demand consume significant network resources and wireless bandwidth at times of peak usage resulting in a requirement for providing excess capacity to meet sudden increases in demand for satisfactory service.

Quality audio streaming requires about 100 kilobits per second (Kbps) per audio stream. Thus, audio (as well as video streaming) during daytime and early evening hours will likely require significant wireless bandwidth and network resources, which would be underused at other times. Thus, providing quality audio via streaming audio will necessarily be expensive if each consumer were allowed to individually customize the content.

As an example, consider a metropolitan area with potentially hundreds of thousand mobile users who might download MP3 audio files over the 3G network while commuting. If, on average, each user attempts to download about fifteen minutes of high quality MP3 audio content corresponding to about 115 Mbits of data, then 100,000 users would require the delivery of 11.5 Trillion bits of data during a small time period. This is a challenge during peak network usage hours. Thus, cell sites serving the primary commuter routes used by the mobile users or serving certain lunchtime locations and the like would be severely stressed, resulting in un-acceptably long audio file downloads or even the inability to meet the demand for the downloads.

In addition to streaming audio, audio files, such as MP3 files, are often distributed from web sites over the Internet using the file transfer protocol (FTP). Again, in the wireless context, the transfer of such files is likely to contribute to quality of service problems during times of peak use of cellular voice services (such times generally being daytime and early evening hours). The resulting network congestion caused by such peak demands may disrupt cellular voice services, the audio file transfers or both. Providing sufficient capacity to meet such peak demand will again result in underuse of a significant fraction of the network resources during off-peak times.

The investment risks associated with building and deploying the infrastructure underlying 3G specification and other high data rate content delivery technologies increase with underused capacity. In addition, the actual success and widespread adoption of the 3G wireless specification may be of limited appeal to more cost-sensitive consumers. Wide variations in demand under content delivery models being considered presently result from the use of the 3G high-speed data networks essentially as passive pipes. Thus, a different more intelligent content distribution mechanism is needed for efficient use of 3G and other high-speed data networks.

### SUMMARY OF INVENTION

The present invention provides methods and systems that efficiently use 3G high-speed data networks to provide and coordinate personalized audio content selection and distribution.

An exemplary system for providing audio content comprises means for presenting a plurality of audio segments, means for authenticating user equipment prior to downloading audio content to the user equipment, a server for storing selected audio segments, and means for sending a particular stored audio segment in accordance with a category associated with the particular stored audio segment. One or more of these means may be implemented in software, hardware, or a combination thereof. The means for presenting a plurality of audio segments includes, for example, a web-page, a menu accessible by voice commands, print media and the like. The system may further comprise a software agent for waking a sleeping client device so that it can accept audio content.

In one aspect of the present invention, regional wireless servers are positioned in the 3G high-speed data network to allow an audio service provider to store and regularly update a large and diverse collection of audio content. An exemplary client device comprises data receiving/transmitting means, such as a 3G high speed medium, data storage means, such as a large capacity micro-hardrive, and computing means, such as a central processing unit (CPU). The computing means may advantageously control the content download process as well as the storage and playback of content. An exemplary client device for receiving and playing audio content comprises means for receiving audio content from an authorized network node, storage means for storing the received audio content, user interface means for presenting stored audio content for playback selection and playback means for outputting audio content.

An exemplary method for providing audio content by a wireless service provider comprises receiving a selection of an audio segment, storing the selected audio segment at an intermediate node, and downloading the audio segment in accordance with a delivery priority to a client device.

The audio content may comprise one or more audio segments, each being, for example, a complete audio program or track. The audio segment may be categorized by associating it with one of three categories, each of which corresponds to a different delivery priority. The three categories are discussed only to illustrate the invention and do not limit the invention in any way since more than three categories could also be employed. [Less may pose a problem since there is prior art that allows breaking news to be delivered by interrupting an ongoing program.]

Category 1 applies to content that should be delivered as soon as possible, for example, within the hour if not minutes. Such content could include dangerous weather conditions, emergency or breaking news alerts.

Category 2 applies to content that should be delivered relatively quickly (but not as quickly as category 1 content) within hours. Such content could include daily news headlines, sports news, weather and so on. In some cases, category 2 content, such as the morning news, news in general, weather and traffic, may be required to be delivered by no later than a specified time. Category 2 content may also be recurring in nature in that the similar updated selections of content are likely to be delivered periodically, for example, each day, twice a day, every hour and so on.

Finally, category 3 applies to content that is not urgent and does not change frequently. Such content may include music, audio books and so on. Category 3 content may accordingly have a relatively low delivery priority. Category 3 content may also require significant bandwidth and may be less amenable to reduction in audio quality.

In another aspect of the invention, audio content may be stored on a server for different lengths of time depending on its category. Such stored audio content may comprise an audio segment sent to the server in response to a request for the audio segment. Such a request may be made either at a user interface (or a gateway) provided by the wireless service provider or at an audio content provider's site directly with delivery being via the wireless network, which network stores the content on the server in the course of making the delivery.

In another aspect of the invention, the wireless service provider may provide an interface or gateway for selecting audio content from one or more audio content providers. Audio content may be presented, without limitation, on a web-page, a printed page, over a voice telephone link, and via a cellular voice service connection. A customer may subscribe to a service for periodic delivery of audio content, or custom order individual audio selections, or receive a particular audio segment as part of a bundle with non-audio services, or receive audio content as part of a package of media content. Upon receiving a request for an audio segment, a user request-playback data file may be created or updated by the server.

Audio content is delivered in accordance with the invention via a dynamic pipeline. In particular, in accordance with the present invention, wireless service provider does not merely pass audio content from a content provider to a user. Instead it takes into account a delivery priority, and optionally other considerations, to efficiently use bandwidth and other network resources for delivering content.

A method of using a dynamic pipeline may comprise receiving an audio segment for delivery to a user equipment and executing a user request-playback file related to the received audio segment. Executing the user request-playback file may require determining a category for the audio segment and delivering the audio segment to the client device in accordance with the determined category. Such a client device may be a receiver in an automobile or a mobile device carried by a user.

In another aspect of the invention, the delivery of audio content can be resumed at about the point of a prior interruption in delivery. This capability leads to better bandwidth use and reduces or eliminates the need to transmit large audio segments to a client device. To this end, an identifier is assigned to the audio segment and the audio segment is broken into several audio files. If the download process is disrupted, then only the disrupted audio files needs to be resent. This reduces the overhead of having to resend the entire audio segment and makes the downloading process interruptible with a small increase in the overhead. The interruptible downloads may result in downloading a given audio segment during two or more spaced apart time intervals.

The customer, the wireless service provider or another entity may thus attach a category designation to an audio segment to specify, for example, a time prior to which the audio segment must be delivered, a category for the delivery of the audio segment, a time period during which the audio segment can be delivered, and/or an order in which the audio segment must be delivered. The order may specify an audio segment or file to be delivered first, an audio segment or file to be delivered last, a preceding audio segment, and an audio segment that follows another audio segment or file. Default queuing strategies such as first in first out (FIFO) or last in first out (LIFO) may be deployed as well. Further, a schedule for downloading may include immediate or periodic downloading, delivery during a specified time interval, specified so that a client device is scheduled to be ready to receive downloads, delivery during low usage of a wireless network, or delivery in response to detecting availability of low cost bandwidth. In addition, ordering of audio segments, for instance for playback, may also be undertaken, by a user after delivery or when selecting the audio content.

Some wireless service providers may elect to price downloads based on the time of the day to encourage use of resources that otherwise may be underutilized in off-peak hours. Thus, the ability to detect a period of low cost bandwidth availability may advantageously trigger downloading of audio content. In addition, automated authentication allows downloading to commence or resume in response to successfully authenticating a client device.

The invention is further described in detail below with the help of the following illustrative figures.

### DETAILED DESCRIPTION OF THE FIGURES

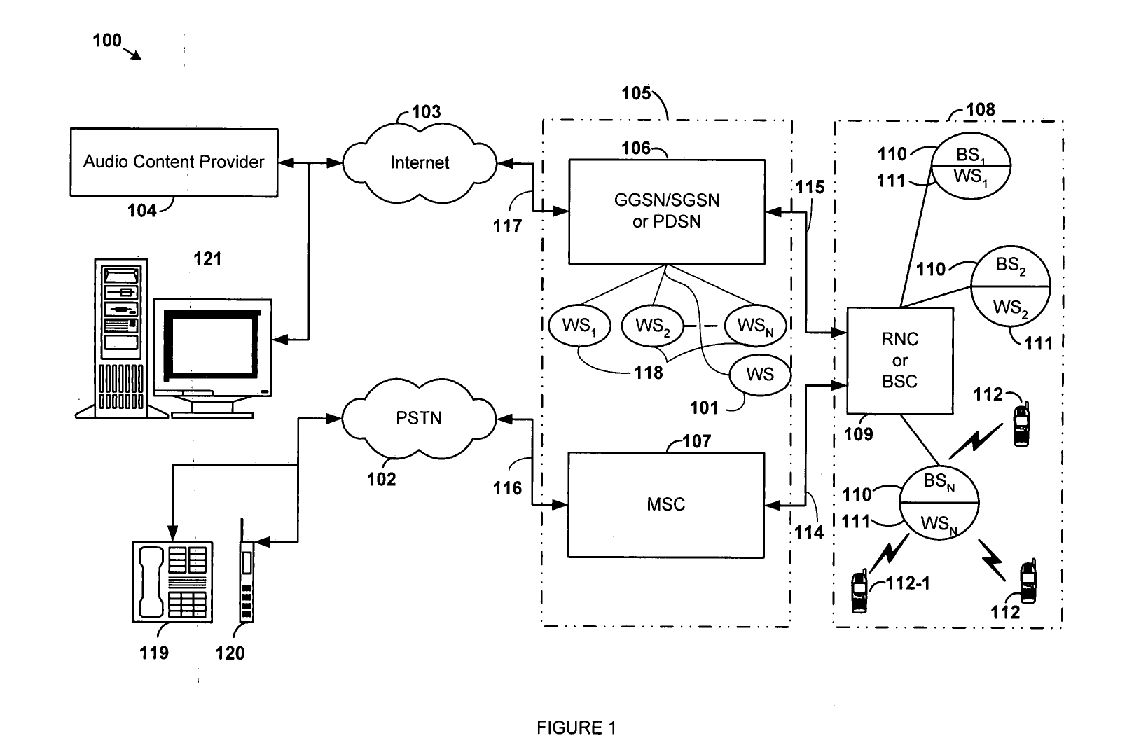

FIG. 1 is an illustrative representation of a 3G high speed data transfer network in which the present invention can be deployed.

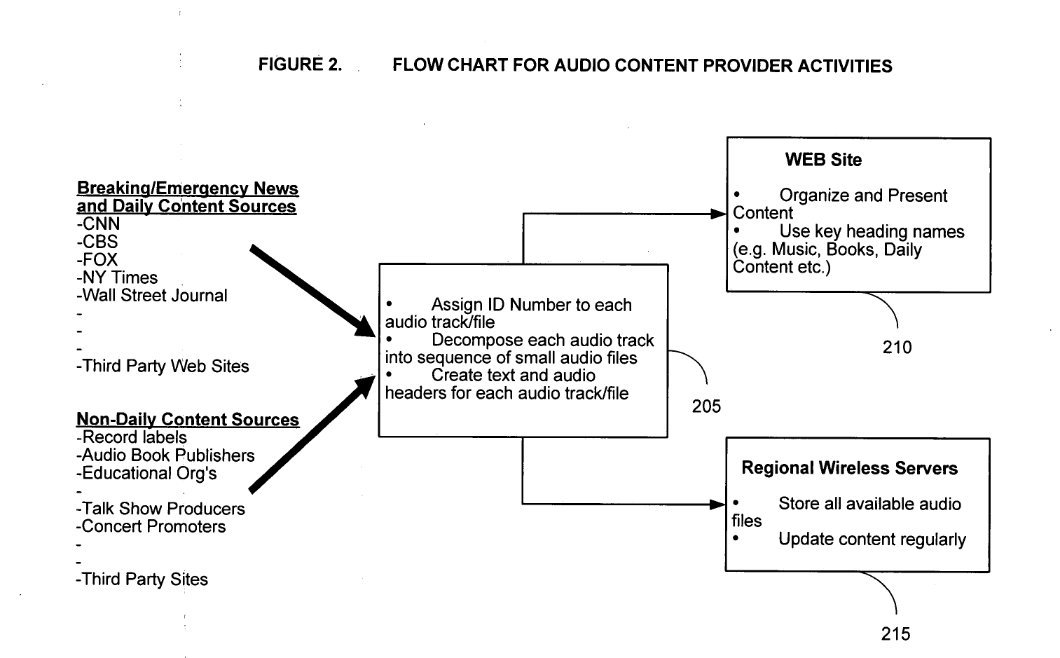

FIG. 2 is an illustrative flow chart of a process performed by an audio content provider.

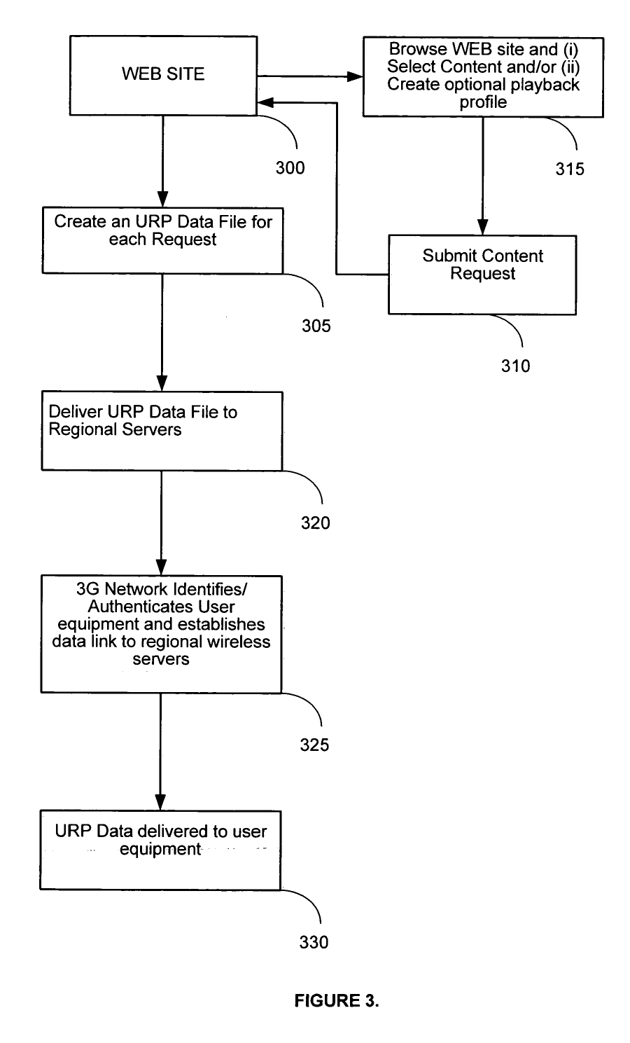

FIG. 3 is an illustrative flow chart of subscriber browsing and related activities.

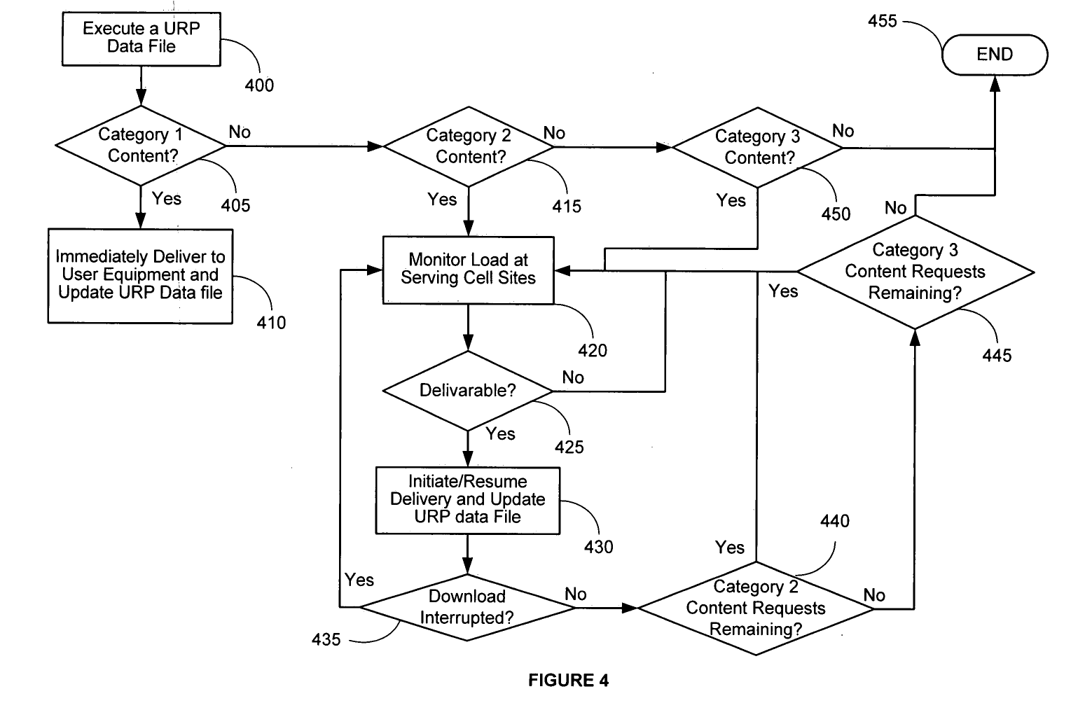

FIG. 4 is a flow chart illustrating processes performed by a regional network node in accordance with the present invention.

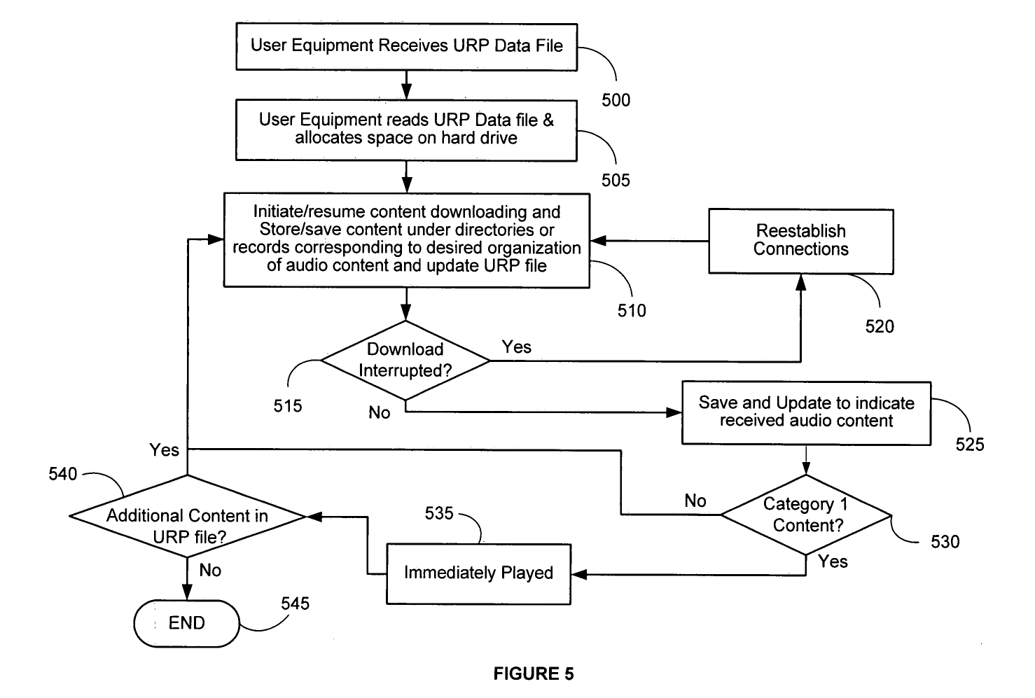

FIG. 5 is a flow chart illustrating a process performed by at a user equipment in accordance with the present invention.

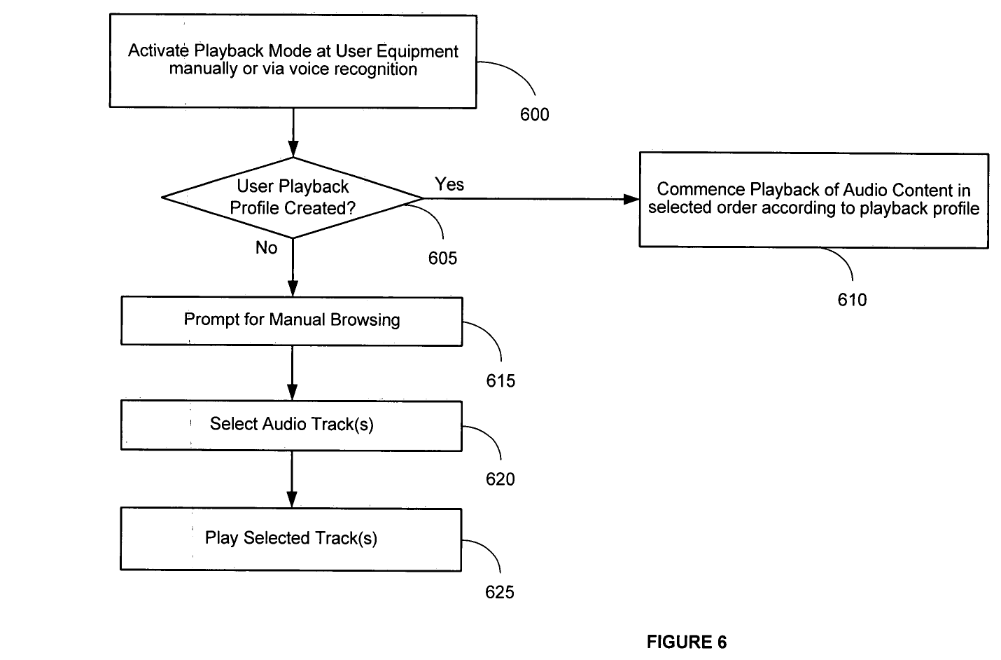

FIG. 6 is a flow chart illustrating the playback of downloaded audio content by a user equipment.

### DETAILED DESCRIPTION OF THE INVENTION

The present invention takes advantage of periods of low network traffic or cheap access rates to coordinate delivery of audio content such that available resources are used efficiently. It enables wireless service providers, possibly in conjunction with the audio content provider, to create reasonably priced audio content selection and delivery services for greater consumer appeal. For example, in a three-category model, in return for paying a reasonable monthly fee, a user may be able to select and receive several hours of personalized category 3 audio content per week and a limited amount (e.g. 1 hour) of category 2 content each day, in addition to rapidly delivered category 1 audio content.

Each audio segment may be, for example, a complete audio program or track and may be delivered as a collection of several audio files. Each audio segment or collection of audio segments may be categorized to indicate an associated delivery priority.

In an illustrative three-category embodiment of the invention, category 1 audio content has the highest priority and may be delivered within the hour or within minutes. Such content may include dangerous weather conditions, emergency or breaking news alerts and the like. The user equipment may advantageously produce a visual and/or audio prompt (blinking light or emitted sound) to indicate the arrival of category 1 content.

Category 2 audio content has the next highest delivery priority and may be delivered within hours or no later than a specified time. Each of three categories corresponds to a different delivery priority. Category 2 audio content may include daily news headlines, sports news, weather and so on.

Category 3 audio-content has the lowest delivery priority and its delivery is not as time critical as the first two categories. Category 3 audio content may include music, audio books and so on.

Category 3 may require the highest audio quality and is the most data intensive and may require compression, such as full MP3 compression to a rate of about 128 Kbps or in accordance with improved or alternative methods. In the context of MP3, an hour (measured by playback time) of category 3 audio corresponds to about 460 Mbits of data. Audio content in categories 2 and 1 may be acceptable at lower quality, not unlike FM radio transmissions, and may be compressed to a rate of about 64 Kbps. Thus, half-hour of category 2 content corresponds to about 115 Mbits of data. Most 3G high-speed data networks anticipate offering subscribers average data rates in the range of hundreds of kilobits per second (Kbps). For example, the UMTS 3G network specifies an average data transfer rate of about 384 Kbps and even higher if the user equipment is stationary. A data transfer rate of 384 Kbps means that 1 hour of category 3 content can be delivered to a user in about 20 minutes and half-hour of category 2 content can be delivered in about 5 minutes.

The automatic and coordinated delivery of selected category 2 and 3 content to users' wireless terminals may further be based on the detection of low traffic or low access charges in a cell site. Such periods are typically overnight (between about 11:00 PM and about 6:00 AM), most of the selected audio content is advantageously delivered during that time. This is also a period when the user equipment is likely to be stationary thus allowing higher data transfer rates.

Audio content may, of course, be delivered during daytime hours as well, especially when it is determined that the serving cell site is experiencing sufficiently low traffic volume that a meaningful download of content can be completed.

Delivery of category 1 and 2 content has the highest delivery priority. After substantially all users connected to a base station or transmitting node have received their respective category 1 and 2 content, delivery of category 3 content commences. Thus, delivery of selected category 3 content takes place as network traffic/usage permit, but, in general, it is expected that 1 hour of category 3 content will be delivered over a period not exceeding a few days.

FIG. 1 illustrates a 3G network having voice and high-speed data capabilities. Voice calls are handled by mobile switching center (MSC) 107, which provides an interface between regional radio access network 108, and public switched telephone network (PSTN) 102. Data transfers between the radio access network 108, and Internet 103, are typically handled by nodes 106, which may comprise either the GGSN (Gateway General-packet-radio-service Support Node) and SGSN (Serving General-packet-radio-service Support Node) for the UMTS 3G standard or PDSN (Packet Data Serving Node) in accordance with the CDMA 2000 3G standard. Regional core network 105 containing nodes 106, also contains other equipment (not shown) used to provide other support functions such as user authentication, security, billing, user profiles, visiting user registration and so on.

Regional wireless servers (WS) 118 are located within regional core network 105 and/or within regional base station 110 as illustrated by WS 111. At least one wireless server (e.g. WS 101) is located within regional core network 105 and is assigned to provide overall coordination between servers WS 118 or WS 111. Regional wireless servers 118 and/or 111 are able to communicate with audio content provider 104, user equipment 112 and with other equipment within regional core network 105.

A typical regional wireless server 118 consists of a processor and related memory (both not shown) and access to one or more large capacity hard drives. The memory contains instructions in the form of software that the processor interprets and executes. One or more large capacity hard drives are used to store compressed audio content that content provider 104 makes available to users. The low cost of large capacity hard drives (e.g. 150 Gbytes for under $100) makes it practical for the wireless servers to store the entire available content of the audio content provider (a 150 Gbyte hard drive can store about 2600 hours of high quality MP3 audio).

According to one aspect of the invention, an audio track or program that is available for selection by a user has an identification number or code that is also stored and downloaded with it. Also, such an audio track or program is stored in a format that enables interruption of content delivery when a target mobile user equipment can no longer be serviced, for example if it exits a cell or loses power. At a later time, content downloading may be resumed at about the point of the interruption. This feature enables content downloads to resume without requiring extensive retransmission of already delivered content. Further, an audio content provider may update the audio content stored on the wireless servers as new content becomes available for distribution.

User equipment 112 comprises a 3G wireless high speed data modem, a processor (e.g., TI C55×DSP), random access memory, a large capacity micro-hard drive and stereo analog output ports that can be connected either to loudspeakers or to headphones. User equipment 112 may advantageously include MP3 file management software that creates directories under which downloaded content can be stored and accessed for playback. These directories may by default mirror the organization of the available content on the audio content provider's web site. The file management software may take advantage of the aforementioned track identification numbers to enable the efficient organization and navigation of downloaded audio content.

Representative user equipment 112-1 may communicate with representative wireless server 111. Wireless server 111 may be associated with regional base station 110. Alternatively, wireless server 111 may be located at the radio network controller 109 itself. Generally, regional core network 105 may monitor the level of voice and data traffic flowing through base station 110. As a consequence, the available data capacity (e.g., in Kbps or Mbps) at any given time for base station 110 serving user equipment 112-1 may be determined and provided to wireless server 118.

Available audio tracks or programs may be stored on wireless servers as a sequence of small files. The first file in a sequence of such files may be a text file containing an identification number and title of the audio track or program. A second file may audibly render the name of the audio track or program. The collection of the subsequent small audio files, when concatenated represents the audio file of the audio track or program. Further, the size of each of the audio files may advantageously be chosen to provide a high probability of each file being successfully downloaded by a user equipment during brief time slots of available capacity.

For example, even though a cell site may be very busy during peak hours, brief time slots, for example, on the order of tens of seconds, will become available as voice calls are terminated. These time slots may be used, in one aspect of the invention, to download available files. A representative small, compressed audio file may be about 1.28 Mbits corresponding to about 10 seconds of high quality real-time audio (for lesser quality audio, the size of the file would be less). The small 1.28 Mbit audio file may be downloaded in about 9 seconds at a user equipment assigned a download speed of 144 Kbps (a reasonable estimate for a terminal in a mobile vehicle in a UMTS 3G network).

At the relatively slow download speed of 144 Kbps, a small audio file has a high probability of being successfully delivered to the user equipment. In the event the small audio file cannot be successfully delivered within a cell site, the probability becomes increasingly high that the small audio file will eventually be successfully downloaded as the mobile user equipment enters successive cell sites. Selected audio programs are advantageously delivered throughout the day and night, to the extent permitted by the network loading. Of course, the time at which content can be delivered may be further controlled. For example, the user equipment may be powered or available only during one or more time intervals.

In an exemplary embodiment of the invention, an audio segment stored on the servers and available for selection is assigned a unique identification number or code having four fields:

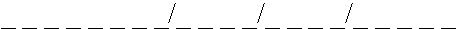

The first field identifies the audio segment, for example, a track, a collection of audio tracks or audio program, and may also enable alphabetical organization of the content by the user equipment file management and navigation system. For example, the first few positions in the first field may consist of alphanumeric data identifying the track and the key heading to which it belongs. (e.g. “Music” or “MorningSummary” etc.). The last few positions of the first field may consist of a group of 3 or more letters in the title of the audio track.

The second field identifies the number of audio files (of a known size in Mbits or Mbytes) that collectively may form the audio segment. Advantageously, the second field may be decremented as each small audio file is successfully downloaded. For example, a number of 360, prior to downloading, would mean that there are 360 audio files constituting the entire audio track. As downloading commences, this number will decrease to indicate the number of small audio files remaining to be downloaded.

The third field identifies the audio compression, if any. The fourth field identifies a category associated with the track or program, i.e., the audio segment. The fourth field may also provide a specified time of daily delivery, e.g., 20600 indicating content category 2 to be delivered at about 6:00 am.

Users may use home/office PC 121 to browse the audio content provider's web site for available audio content. Alternatively, users may use telephone 119 or 120 with the optional aid of a printed audio content guide to browse and select preferred content.

The available audio content need not be explicitly identified as being associated with a category, and instead the association may be implicit. For example, an audio provider's web site may organize the available content under headings such as: “Music”, “MorningSummary”, “AfternoonSummary”, “Books”, “Courses”, “TalkShows”, “Concerts”, etc. Heading names such as “MorningSummary” and “AfternoonSummary” (or any other such identifier) may be used to list the available category 2 content that is available for morning and afternoon delivery, individually or as user constructed “packages.” Subheadings under each key heading may further delineate the content according to its type. For example, under Music, subheadings such as R&B, Jazz, Rock&Roll etc. may be used. Under MorningSummary, subheadings such as “Morning News”, “Daily Weather”, “Morning Sports Round-Up” and so on might be used.

An illustrative flow chart of a process performed by an audio content provider is shown in FIG. 2. A number of sources, such as CNN, CBS, FOX, New York Times, Wall Street Journal and the like provide breaking news and other daily audio content. Non-daily audio content may be provided by record labels, audio book publishers, educational-organizations, talk show producers, concert promoters, and the like. During step 205, ID numbers are assigned to audio tracks or files, the tracks and files are decomposed, as required, into smaller audio files and the text and/or audio header files are created for the audio tracks and files. In step 210 the audio content provider then organizes the audio content in a Web site having heading names and organization that facilitates browsing and searching. Alternatively, in step 215 the audio content provider then stores, updates the audio files on servers at a wireless service provider.

When a user browses and selects content from the content providers web site (or does the same via the telephone), a user request-playback data file is created containing the identification numbers of the selected audio tracks. While browsing the web site of the content provider, users may also create customized audio programs by selecting a desired playback profile. Such customized audio programs may specify the order in which some or all of the selected content is to be played back. For example, the identification numbers within the user request-playback data file may be sequentially ordered to reflect the selected playback order. The use equipment then plays the audio content in the specified order. Typically, category 1 content may be audibly rendered first, followed by category 2 content and then the ordered category 3 audio content. In the event a user does not select a playback profile, the track identification numbers may be entered into the user request-playback data file in a default order, such as the order of selecting the downloaded content. The order of playback of delivered audio content may also be left to the user to decide via manual means.

FIG. 3 in an illustrative flow chart of a process performed by user equipment operated by a subscriber or customer. In step 315 a subscriber or customer browses website 300, selects audio content, and, optionally, creates a playback profile. In step 310, upon completion of audio content selection by the user, a content request is submitted to website 300. In step 305, a user request-playback (URP) file is created for the content request. Next, in step 320, the URP file is delivered to a regional server, such as server 118 in FIG. 1. Then in step 325, a 3G network identifies and authenticates the user equipment and then establishes a data link to it. Lastly, in step 330, URP data is delivered to the user equipment for subsequent or concurrent use.

According to another aspect of the invention, the audio content provider's web site enables each subscriber to access personal pages, via password, that will provide a listing of downloaded audio content and the latest user selected playback profile. There may also be provided an option to create/update a playback list from the downloaded content for automatic and ordered playback of downloaded content.

Accordingly, the user request-playback data file may include an indicator to inform the user equipment whether the order of the audio segments within the user-request-playback data file, is important for rendering the audio content. If the user selects a playback profile, then the indicator may also inform the user equipment to playback a specified number of tracks in the provided order. For example, the name of the user-request-playback data file may include the user name/identifier, the date and time at which the selection was made and a number that indicates whether or not the user has selected a playback profile. The value “P” of the number may indicate that the first “P” tracks (i.e. unique ID numbers) are to be played back in the order in which they appear in the user-request-playback data file.

The following represents an exemplary format for the user request-playback data file in which the user request-playback data file name is followed by L track ID numbers:
User ID/month/day/year/time/Playback_Order_Indicator; audio track ID number 1; audio track ID number 2; audio track ID number 3 . . . audio Track ID number L; End of File Symbol.

In operation, after selecting audio content, a user may leave his or her wireless terminal “ON” (e.g., in a “power-saver” mode). A software agent may then wake up a sleeping user equipment for delivery of selected audio content in a timely manner.

In another aspect of the invention, user equipment may be detected and authenticated using the well-known methods and protocols by which a 3G regional network automatically detects, identifies and authenticates user equipment. Upon validation and identification of each user, the user ID is sent to the regional wireless servers to determine if a user request-playback data file has been stored. If there is no user request-playback data file on record, then no further action need be taken by the network. If a user request-playback data file has been stored, then the regional wireless servers, optionally, also send the user request-playback data file to the user equipment. In addition, the compressed audio tracks stored on the wireless servers are sent to the user equipment, where they may be stored in encrypted form and decrypted by the user equipment by any number of well-known methods.

Next, the regional wireless servers read and interpret the unique identification numbers contained in the user request-playback data files and use that information to prioritize the delivery of audio content.

The user equipment reads the user request-playback data file and, prior to downloading, uses the information in field 2 of the aforementioned track identification numbers, to allocate regions on the micro-hard drive of the terminal for each of the tracks to be downloaded. In addition, the user equipment may use the information in field 1 to determine a default directory or folder name for saving the downloaded audio content.

Category 1 user requests are sent first. Once category 1 content is in the process of being serviced and if cell site capacity allows, category 2 user requests are delivered to the user equipment. Category 2 content requests with a specified time of delivery that is closest in time are serviced with the highest available priority. For example, a category 2 content request with a specified 6:00 am delivery time would be serviced before a request to be delivered at about 7:00 am. Following delivery of category 2 content requests in a serving cell site, category 3 content requests are delivered. Typically, during overnight hours user equipment is stationary and serviced by the cell site of the user's home location. During daytime hours, the user equipment may either be stationary or mobile.

As the files associated with a selected track are successfully downloaded, a field in the user request-playback file for that track (e.g. field 2 of the track identification number) is decremented both at the user equipment and at the wireless server. In the event of an interrupted download, the field in the user request-playback file has a value representing the number of audio files remaining to be downloaded.

FIG. 4 depicts a flow chart illustrating processes performed by an exemplary regional wireless network. A Regional Wireless Server, such as server 118 in FIG. 1, starts to execute a URP file during step 400. During step 405, if category 1 content is present in the URP file, then control flows to step 410, during which it is delivered to the targeted subscriber as soon as possible and the URP data is modified to indicate the delivery. If category 1 content is not present at step 405, then control flows to step 415. If category 2 content is detected, then at step 420 the load at a serving cell sites is monitored. At step 425, it is determined if the category 2 content can be delivered. If category 2 content cannot be delivered, control flows back to step 420 for a subsequent retry. If the category 2 content can be delivered, then step 430 is performed, during which content delivery is initiated or resumed with any required modifications to the URP data file. Following initiating or resuming delivery of category 2 content, control flows to step 435 for determining whether the download process has been interrupted. This may be required to accommodate increased demand for other services, such as cellular voice service. In the event, an interruption is detected, control flows back to step 420. Otherwise, control flows to step 440 to determine whether there is remaining category 2 content to be downloaded.

If remaining category 2 content is detected, control flows back to step 420. Otherwise, control flows to step 445, during which category 3 content is detected. If category 3 content is detected, control flows to step 420 for delivery of such content. Otherwise, in the absence of any remaining category 3 content to be delivered, the method terminates. Also, the in the absence of detected category 2 content during step 415, control flows to step 450 for detection of category 3 content. If category 3 content is detected, control flows to step 420. Otherwise, control flows to step 455 for termination of the process.

If the downloading is interrupted, the next time the user equipment re-establishes connectivity with the wireless servers, a server locates and reads the user request-playback data file to determine the remaining audio files to be downloaded. This information also indicates the memory location within the server database storing the content still to be downloaded. Similarly, the user equipment may use this information to determine the exact location on the micro hard drive where the storage of the resumed download should continue.

FIG. 5 is a flow chart illustrating a process performed by user equipment. During step 500, the user equipment receives initial URP data as described, for example, in FIG. 3. Next in step 505, the user equipment reads the URP file and allocates space to accommodate the expected audio content. In step 510, audio content downloading is initiated or resumed with the audio content being saved in appropriate directories or fields. In step 515, the user equipment determines if there was an interruption in the downloading process. If the downloading was interrupted, step 520 is performed, during which communication with the wireless servers is reestablished for resumption of downloading of audio-content. In the absence of interruptions, step 525 is performed, during which the URP file of the audio content is updated and saved. Next in step 530, the user equipment determines whether the downloaded content was category 1 content. If it is, then in step 535 it is immediately played. In either case, step 540 is then performed, which determined whether the process has finished reading the URP file at step 510. Otherwise, the process ends at step 545.

As selected content is downloaded to the user equipment, an audible and/or visual signal may alert the user to the availability of certain audio content for playback. The user may activate the browse-playback mode of the terminal, for example, by using voice recognition. If the user has selected a desired playback order when originally selecting the content or has later created a desired playback order, then playback commences upon the start of playback mode. If the user has not selected a playback order, then the user may be prompted visually and/or audibly by the user equipment to manually browse and select content for playback.

The manual browsing of downloaded content may be accomplished, for example, with two buttons. Button 1 may be a two-position “rocker-type” button that is used to scroll forward and backward through menus and “highlight” each available choice at each level within the menu. Button 2 may then be used to select a choice that is made with button 1. Thus, button 2 may be similar to the “Enter” key on the keyboard of a PC.

The user equipment may also include a file management system consisting of key directories, having default names similar to those used on the audio content provider's web site. In addition, under each key directory there may be alphabetical sub-directories” “A”-“Z”. As selected content is downloaded, the similar naming defaults may be used to automatically store the content. In addition, as part of the file management and navigation system, text and associated audio files, each containing user prompts may pre-stored on the micro hard drive of a user equipment prior to the user taking delivery of the user equipment. For example, the names of the key directories and the letters of the alphabet, for the sub-directories may be pre-stored. When the user navigates through the directories, as described below, the user equipment may play the pre-stored audio file to allow the user to hear the name of the directory. Similarly, the pre-stored small text file may be used to visually display the directory name on a small display. Updates to the pre-stored text and associated audio files may be sent by the audio content provider over the wireless network to end-user terminals to reflect occasional updates to the names of key directories on the web site.

When the user arrives at the desired key directory, the user would press button 2 to cause that directory to be selected. Then the user may scroll through the alphabetical sub-directories to find the letter that corresponds to the first letter of the title of the audio track of interest and press button 2 causing that sub-directory to be selected. During this particular scrolling process, the first two files of each audio track under consideration are executed (i.e. the text file and the audio file containing the title of the audio track) to allow the user to hear and see the name of each audio track under consideration. When the user hears the title of the audio track of interest, it may be selected for playback.

Finally, during playback of a selected audio track, it may be paused or caused to resume using a toggle button, for instance, using button 2. Further, rapidly pressing button 2 twice may commence manual browsing and playback mode. When the user wishes to stop listening to audio material, then the user may de-activate the terminal by using a button or voice activated controls.

FIG. 6 is a flow chart illustrating the process of playing back downloaded audio content by a user equipment. During step 600, the playback mode is activated and control flows to step 605. If a user profile is detected, then control flows to step 610, during which received audio content is played back in accordance with the playback profile. However, if no playback profile is detected, then control flows to steps 615 and 620, in which the user is prompted to browse and select audio content for playback. During step 625, the selected audio content is played back.

The illustrative descriptions of the application of the principles of the present invention are to enable any person skilled in the art to make or use the disclosed invention. These descriptions are susceptible to numerous modifications and alternative arrangements by those skilled in the art. Such modifications and alternative arrangements are not intended to be outside the scope of the present invention. The appended claims are intended to cover such modifications and arrangements. Thus, the present invention should not be limited to the described illustrative embodiments but, instead, is to be accorded the broadest scope consistent with the principles and novel features disclosed herein.

1. A method for delivering audio content comprising the steps of:
storing a request-playback file identifying audio segments to be sent to user equipment;
executing a request-playback for the audio segment;
determining a category for the audio segment from the request-playback file, wherein the category identifies a delivery priority for delivering the audio segment; and
delivering the audio segment to the user equipment in accordance with the determined category.

2. The method of claim 1 further comprising storing the audio segment.

3. The method of claim 2, wherein the category corresponds to one of urgent delivery priority, periodic delivery priority, no later than delivery priority and flexible delivery priority.

4. The method of claim 2, wherein for urgent delivery priority the audio segment is to be delivered in less than one hour.

5. The method of claim 2, wherein the step of delivering includes initiating and resuming delivery of the audio segment.

6. A method for providing audio content comprising:
classifying an audio segment into three or more categories, wherein each of the categories corresponds to a delivery priority for delivery of the audio segment;
assigning an identifier to the audio segment;
decomposing the audio segment into one or more audio files;
attaching descriptors to at least one of the audio segment and the audio file; and
sending the audio files for downloading over a wireless link.

7. The method of claim 6, wherein the audio segment is sent to a server.

8. The method of claim 6 further comprising receiving a request for a specified audio segment.

9. The method of claim 8, wherein the request comprises a time period during which the audio segment must be delivered, and an order in which the audio files must be delivered.

10. The method of claim 9, wherein the order specifies one of a preceding audio segment, a first audio segment, a last audio segment and a following audio segment.

11. The method of claim 6 further comprising
presenting a plurality of audio segments on at least one of a web-page, a printed page, over a voice telephone link, and via a cellular voice service connection; and
receiving instructions selecting one or more of the audio segments.

12. The method of claim 11 further comprising:
creating a request-playback data file based on the selection and further received instructions; and
providing the request-playback data file to a server.

13. The method of claim 11 further comprising updating the plurality of audio segments.

14. The method of claim 12, wherein the request-playback data file includes an indicator to indicate whether an order of audio selection therein also specifies the order in which downloaded audio selections are to be played back.

15. The method of claim 6, wherein the step of sending occurs at one of the times:
immediately, periodically, during one of specified time intervals, during low usage of a wireless network, and in response to detecting availability of bandwidth.

16. The method of claim 6, wherein the step of sending comprises sending the audio files in two or more spaced apart time intervals.

17. The method of claim 6, wherein the step of sending comprises sending the audio files in response to successfully authenticating a user equipment to which the audio segment is being sent.

18. A method for providing audio content comprising:
receiving a selection of an audio segment at an audio content provider;
storing the selected audio segment at an intermediate node; and
sending the audio segment in accordance with a selected category to a user equipment, wherein the selected category is selected among three or more possible categories.

19. A system for providing audio content comprising:
means for presenting a plurality of audio segments;
means for authenticating the user equipment prior to downloading audio content to the user equipment;
a web server for storing audio segments selected at the means for presenting; and
means for sending a particular stored audio segment to a user equipment in accordance with a category associated with the particular stored audio segment.

20. A system of claim 19 further having a software agent for waking a sleeping client device, in response to successful authentication, from the web server.
